(19) United States
(12) Patent Application Publication
(10) Pub. No.: US 2008/0231061 A1
(43) Pub. Date: Sep. 25, 2008

(54) Locking device for the closing lid of washing and drying machines

(76) Inventor: Onofrio Rocchitelli, Pogliano Milanese (Milano) (IT)

Correspondence Address: JACOBSON HOLMAN PLLC, 400 SEVENTH STREET N.W., SUITE 600, WASHINGTON, DC, 20004, US

(21) Appl. No.: 12/076,748

(22) Filed: Mar. 21, 2008

(30) Foreign Application Priority Data
Mar. 22, 2007 (IT) MI 2007A 00575

(51) Int. Cl. E05C 19/00

(52) U.S. Cl. 292/303

(57) ABSTRACT

Locking device for the lid (17) of a washing or drying machine, equipped with a locking mechanism comprising an external latch (3) and an internal latch (2) partially housed inside the previous latch.

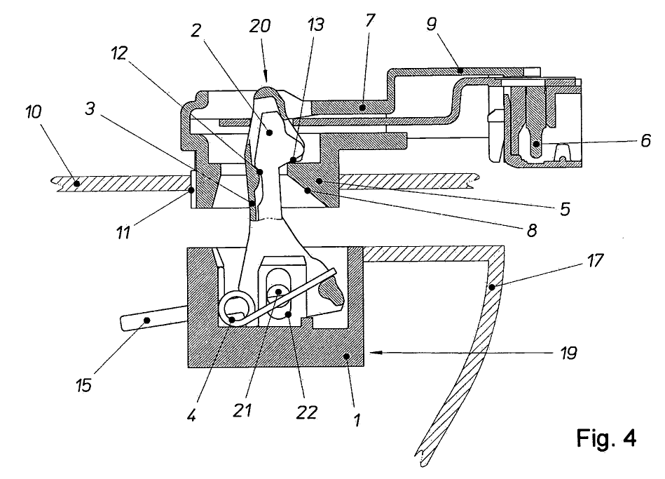

The external latch (3) is firmly attached to an opening handle (15) and subjected to the action of a torsion spring (4), while the internal latch (2) presents on one side a slanted profile (13), and on the side opposite the slanted profile, a shaped profile (12) suitable for inducing a rotation of the latch (3) (FIG. 4).

The present invention concerns a locking device for the closing lid of washing and drying machines.

In this type of machines the loading chamber is closed by a hinged lid fitted with a latch suitable for engaging in a support mounted on the panel of the machine. A lid locking device set up inside the machine takes care of further locking the lid's closing latch, allowing its release only at the end of the machine's operation, and preferably at a preset delay.

There are two types of controls for opening the lid, more precisely a traditional one that achieves the opening by turning a handle, and another (also known as a “tear-off” type, used preferably in cloth dryers, for safety reasons), wherein the opening occurs by applying a relatively small pulling force to the closing lid.

The mechanisms associated with the two types of openings generally differ, as well as their relative latches. There is therefore also a need to hold two different articles in store, depending on the machines to be produced or repaired, and there are also problems and difficulties in realizing machines equipped with both types of opening.

The scope of the present invention is to realize a locking device for the closing lid of washing and drying machines that will be capable of overcoming the limitations and drawbacks of the previous art, and in particular allow utilizing, on the same machine, both the lid opening system of rotating the latch with a handle and the “tear-off” opening system of simply pulling on the lid, based on a particularly simple and effective construction.

According to the invention, these scopes are achieved by a locking device for a closing lid according to claim 1. Other advantageous characteristics are the object of dependent claims.

According to the invention, a latch is supplied as formed by two elements (also designated as an external latch, as the second element is partially housed inside the first), which allows realizing both the lid opening system by rotating the latch with a handle, and the “tear-off” opening system based on simply pulling the lid.

The inventive device advantageously provides for a single return-motion element realized like a torsion spring that serves the double function of inducing the rotation of the latch as well as of acting like an axial compensating element to recover the thickness of the lid gasket, which may vary in its shape, degree of wear, production tolerances, etc.

The additional element or internal latch provides a shaped profile that is particularly effective in pushing the external latch to the outside.

The device according to the invention also comprises a rubber gasket at the bottom of the external latch so as to dampen the return of the latch, caused by the tear-off opening action, to its resting position.

Finally, the device is advantageously inserted in a modular block easily applied to the machine's lid.

The invention will now be described with reference to the enclosed drawings showing a preferred yet non-limiting embodiment of the invention, wherein:

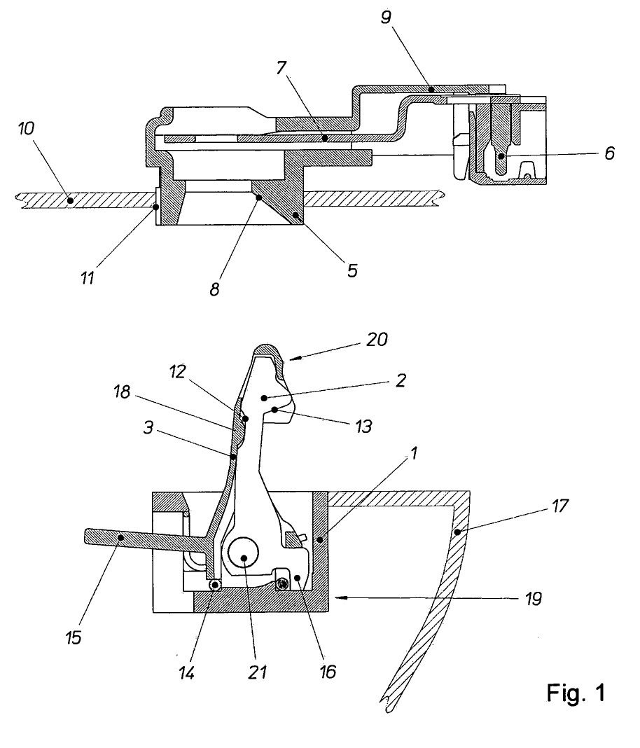

FIG. 1 is a partially sectionalized view of the device according to the invention, in an opened lid position;

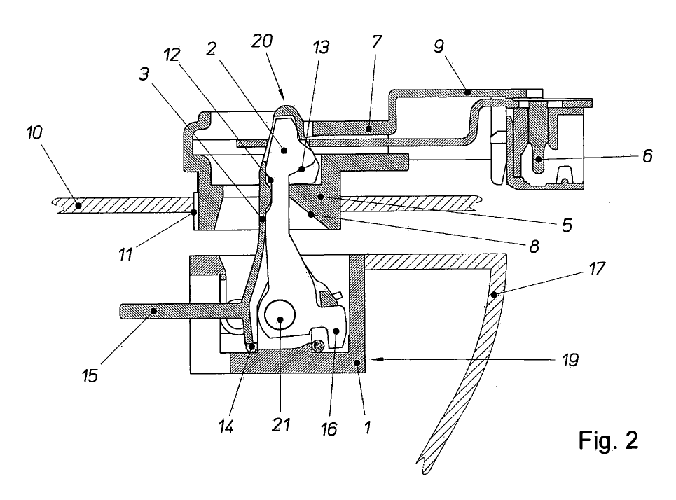

FIG. 2 is a partially sectionalized view of the device according to the invention, in a closed lid position;

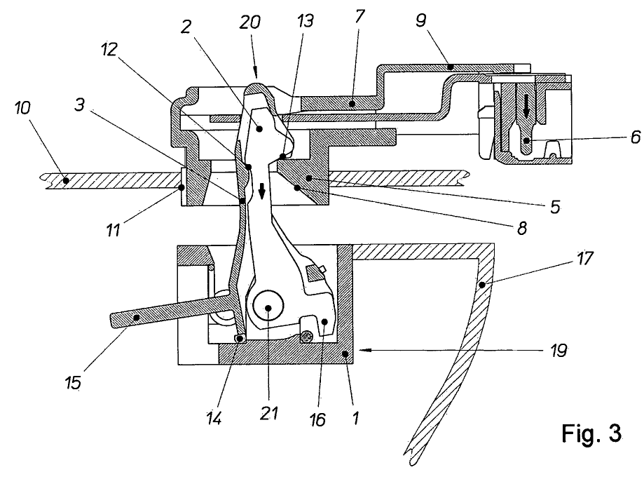

FIG. 3 is a partially sectionalized view of the device according to the invention, in a tear-off opening phase of the lid; and

FIG. 4 is another sectionalized view of the device according to the invention, showing the configuration of the device in an opening phase.

With reference to the figures, a washing or a drying machine according to the invention comprises a front panel 10 fitted with a hole 11 with a lid locking device 9 mounted on the same, which serves the mentioned functions of locking and delayed opening, in order to allow the action of a sliding bolt 7 and of a locking pawl 6. The lid locking device 9 has a template or frame of a rectangular shape with tapered flanks 5, which fits into the hole 11 to serve as an invitation for the latch, and as a stop element 8.

The lid 17 hinged to the machine's front panel 10 carries, next to the hole 11, the device 19 comprising a support 1 that houses a damper 14 made of rubber or other suitable elastic material and adapted to receive the lid locking latch 20.

The lid locking latch 20 is constituted of two elements, an external latch 3 and a second pivoting element or internal latch 2, which is partially housed inside the former.

The external latch 3 has an L-shaped profile suitable for engaging in the portion 8 of the frame 5, and presents a cavity or central inter-space suitable for containing the element 2.

The latch 3 is firmly attached to the lid handle 15 and also connected to the support 1, through a cylindrical pin 21 firmly attached to the support and to an elongated window or slit 22 (see FIG. 4), which is formed in the body of the latch 3.

The latch 3 is subject to the action of a torsion spring 4, as better seen in FIG. 4. The torsion spring 4 serves a double function: it allows the rotation and return of the latch 3 as well as an axial compensation suitable for recovering the thickness of the lid gasket, which may vary in its form, degree of wear or production tolerances.

The element 2, which is forcibly hinged to the cylindrical pin 21, shows on one side a profile that defines a slope or a cam 13, and on the opposite side, a shaped concave profile 12, which comes to face a curved relief 18 provided in the latch 3.

The latch 2 is at its bottom fitted with a tooth 16, acting as a stop element.

The operation occurs as follows:

In the initial phase of closing the lid 17 (which occurs in the same manner, regardless of the presence of the handle 15), the external latch 3 is guided by the inlet slope of the template 5, and one the lid is closed, the torsion spring 4 induces a rotation of the latch 3, and consequently of the internal element 2, to the closing position shown in FIG. 2. The tip of the latch 3 thus moves to abut the portion 8 of the frame 5 and the sliding bolt consequently slides, thus allowing the locking pawl 6 of the lid locking system 9 to snap in.

The opening phase on the other hand occurs in a different manner, depending on whether a tear-off system or a handle is used.

When the lid is opened in a tear-off manner, meaning by applying a pulling force on the lid 17, the rotation of the latches 2, 3 is anticipated by a linear or sliding motion that serves to compensate the reacting force exercised by the lid gasket and by the unavoidable tolerances of the assembly process and its elements. The external latch 3 is initially held back by the template 5 on the lid locking mechanism, while the rest of the device moves on, thus bringing the slope 13 of the external latch 2 in contact with the edge of the portion 8 of the template of the lid locking mechanism.

At the end of the sliding phase, the shaped profile 12 of the internal latch 2 can induce an initial rotation of the external latch 3, as shown in FIG. 3, which is interrupted if the sliding bolt 7 of the lid locking mechanism 9 (in case the pre-set delay has not yet expired, or the machine is still running) is still held back by the locking pawl 6. The lid thus remains blocked, and when it is released, the torsion spring 4 returns both latches to their closing position, as shown in FIG. 2.

Once the locking pawl of the lid locking mechanism has been disengaged, the opening can be effected. By pulling on the lid 17, after the initial sliding of the device, the shifting of the slope 13 of the internal latch 2 induces the rotation of the external latch 3. By acting on the relief 18, the concave profile 12 of the latch 2 shifts the motion of the latch 3 toward the outside, so as to achieve a gradual tearing-off action.

Where a lid opening handle is available, whether integrated or added to the external latch 3, the user acts directly on the handle 15 that is firmly attached to the latch 3 of the device. After ending its rotation, the latch will be free to leave its seat, thus allowing the lid to open.

The rubber damper 14 arranged at the bottom of the support 1 absorbed the impact during the return motion of the latches to their resting position.

The device according to the invention also allows the household appliance to be opened from the inside, if the latch is not blocked by the delaying mechanism.

The invention has been illustrated with reference to preferred embodiments, but it is generally susceptible to other applications and modifications that are intended to fall within the protective range, as will be evident to an expert in the field.

In the claims:

1. A closing device for a lid of a washing machine or a drying machine, comprising a latch hinged on said lid and a support mounted on the front panel of said machine and suitable for receiving said latch,
said latch comprising a first external element or external latch and a second pivoting element or internal latch, partially housed inside the former, wherein said external latch is firmly connected to an opening handle and subjected to the action of a torsion spring, and said internal latch presents on one side a sloping profile, and on the other side opposite the slope, a shaped profile suitable for interacting with the latch.

2. The device according to claim 1, characterized by the fact that said external latch and said internal latch are housed in a modular support.

3. The device according to claim 2, characterized by the fact that said external latch is connected to said support by a cylindrical pin firmly attached to said support and that an elongated window is formed in the body of said external latch.

4. The device according to claim 3, characterized by the fact that said internal latch is forcibly hinged to said cylindrical pin.

5. The device according to claim 1, characterized by the fact that the shaped profile of the internal latch is concave.

6. The device according to the previous claim, characterized by the fact that the external latch presents a curved relief.

7. The device according to claim 1, characterized by the fact that said support houses a damper, made of rubber or other elastic material.
